(19) United States
(12) Patent Application Publication
(10) Pub. No.: US 2009/0053660 A1
(43) Pub. Date: Feb. 26, 2009

(54) FLAMELESS COMBUSTION HEATER

(76) Inventors: Thomas MIKUS, Houston, TX (US); Abdul Wahid Munshi, Houston, TX (US); Peter Veenstra, Amsterdam (NL)

Correspondence Address: SHELL OIL COMPANY, P O BOX 2463, HOUSTON, TX, 772522463, US

(21) Appl. No.: 12/176,232

(22) Filed: Jul. 18, 2008

Related U.S. Application Data
(60) Provisional application No. 60/950,958, filed on Jul. 20, 2007.

(51) Int. Cl. F23N 1/00; B01J 19/00

(52) U.S. Cl. 431/6; 422/198

(57) ABSTRACT

A flameless combustion heater system is described that comprises a flameless combustion heater; an oxidant inlet pipe; a fuel inlet pipe; and a preheater for preheating the oxidant or the fuel, said preheater comprising an oxidation catalyst. A method for starting up a flameless combustion heater is described comprising passing a fuel-oxidant mixture to a preheater comprising an oxidation catalyst to preheat the fuel or oxidant stream being fed to the heater. A method for controlling the temperature of the flameless combustion heater system is also described that comprises controlling the amount of fuel and/or oxidant that passes through the preheater.

This application claims the benefit of U.S. Provisional Application No. 60/950,958, filed Jul. 20, 2007 which is hereby incorporated by reference.

### FIELD OF THE INVENTION

This invention relates to a flameless combustion heater, a method for starting up a flameless combustion heater and a method for controlling the temperature of a flameless combustion heater system.

### BACKGROUND OF THE INVENTION

Flameless combustion heaters are described in U.S. Pat. No. 7,025,940. The patent describes a process heater utilizing flameless combustion, which is accomplished by preheating a fuel and combustion air to a temperature above the auto-ignition temperature of the mixture. The fuel is introduced in relatively small increments over time through a plurality of orifices in the fuel gas conduit, which provide communication between the fuel gas conduit and the oxidation reaction chamber. As described in the patent, a process chamber is in heat exchange relationship with the oxidation reaction chamber.

U.S. Pat. No. 5,862,858 describes the use of a catalytic surface, such as a noble metal, within the combustion chamber of a flameless combustor to lower the auto-ignition temperature of the mixture. This catalytic surface was found to be extremely effective for example, in promoting oxidation of methane in air at temperatures as low as 500° F. (260° C.).

Flameless combustion heaters provide several benefits over conventional fired heaters as described in the aforementioned patents. Flameless combustion heaters can however encounter problems related to maintaining the heater above the auto-ignition temperature of the fuel/oxidant mixture during startup and during operation. Failure to maintain the temperature in the heater above the auto-ignition temperature results in instability of the flameless combustion.

As described in U.S. Pat. No. 5,862,858, the use of catalyst in the flameless combustor can lower the auto-ignition temperature, which makes it easier to maintain the heater above that temperature.

### SUMMARY OF THE INVENTION

This invention provides a flameless combustion heater system comprising: a flameless combustion heater; an oxidant inlet pipe; a fuel inlet pipe; and a preheater for preheating the oxidant or the fuel, said preheater comprising an oxidation catalyst.

One embodiment of this invention provides a flameless combustion heater system wherein the preheater is in fluid communication with the oxidant inlet pipe and fuel is introduced into the oxidant inlet pipe upstream of the preheater such that a fuel-oxidant mixture is passed through the preheater.

Another embodiment of this invention provides a flameless combustion heater system wherein the preheater is in fluid communication with the fuel inlet pipe and oxidant is introduced into the fuel inlet pipe upstream of the preheater such that a fuel-oxidant mixture is passed through the preheater.

This invention also provides a method for controlling the temperature of a flameless combustion heater system and a method for starting up a flameless combustion heater system.

### BRIEF DESCRIPTION OF THE DRAWINGS

FIG. 1 depicts a flameless combustion heater system with a preheater.

### DETAILED DESCRIPTION OF THE INVENTION

The invention provides a flameless combustion heater system that is used in the direct transfer of heat energy released by the flameless combustion of fuel to a process fluid. The heater system has many possible uses and applications including heating underground formations and heating process streams. The flameless combustion heater system is especially useful in conjunction with processes that carry out endothermic reactions, for example, dehydrogenation of alkylaromatic compounds and steam methane reforming. The invention provides a flameless combustion heater system that employs a preheater to improve the startup of the heater and operational stability.

Flameless combustion in a heater can be accomplished by preheating an oxidant stream and a fuel stream sufficiently that when the two streams are combined the temperature of the mixture exceeds the auto-ignition temperature of the mixture, but the temperature of the mixture is less than a temperature that would result in the oxidation upon mixing being limited by the rate of mixing as described in U.S. Pat. No. 7,025,940 which is herein incorporated by reference. The auto ignition temperature of the mixture depends on the types of fuel and oxidant and the fuel/oxidant ratio. The auto ignition temperature of mixtures used in a flameless combustion heater may be in a range of from 850° C. to 1400° C. The auto ignition temperature may be reduced if an oxidation catalyst is employed in the heater because this type of catalyst effectively lowers the auto-ignition temperature of the mixture as described in U.S. Pat. No. 5,862,858, which is herein incorporated by reference.

Using certain fuels, for example hydrogen or dimethyl ether in the presence of an oxidation catalyst can permit flameless combustion to occur at or near ambient temperatures. The flameless combustion may occur at temperatures from about 30° C. to about 1000° C. depending on the fuel and catalyst used.

The fuel conduit provides for the controlled rate of fuel introduction into an oxidation conduit in a manner so as to provide for a desired heat release. The heat release is determined in part by the location and number of openings, which can be tailored to each heater application. The heat release may be constant over the length of the heater, or it may be decreasing or increasing over the length of the heater.

Because there is no visible flame associated with flameless combustion of a fuel, the flameless combustion reaction occurs at a lower temperature than that observed in conventional fired heaters. Due to the lower temperatures observed, and the efficiency of direct heating, the heater may be designed using lower cost materials resulting in reduced capital expenditure.

The flameless combustion heater has two main elements: an oxidation conduit and a fuel conduit. The oxidation conduit may be a tube or pipe that has an inlet for oxidant, an outlet for oxidation products and a flow path between the inlet and outlet. Suitable oxidants include air, oxygen, and nitrous oxide. The oxidant that is introduced into the oxidation conduit may be preheated such that when mixed with fuel, the mixture is at a temperature above the auto-ignition temperature of the mixture. The oxidant may be heated externally to the flameless combustion heater. Alternatively, the oxidant may be heated inside the heater by heat exchange with any of the streams inside the heater. The oxidation conduit may have an internal diameter of from about 2 cm to about 20 cm. The oxidant conduit may however be larger or smaller than this range depending on the heater requirements.

The fuel conduit transports fuel into the heater and introduces it into the oxidation conduit. The fuel conduit may be a tube or pipe that has an inlet for fuel and a plurality of openings that provide fluid communication from within the fuel conduit to the oxidation conduit. The fuel conduit may be located within and surrounded by the oxidation conduit. The fuel passes through the openings and into the oxidation conduit where it mixes with the oxidant and results in flameless combustion. The fuel conduit may have an internal diameter of from about 1 cm to about 10 cm, preferably from about 1.5 cm to 5 cm. Depending on the design, however, the fuel conduit may have a diameter greater than 10 cm or less than 1 cm.

A preferred embodiment of a flameless combustion heater comprises two pipes or tubes. The fuel pipe has an inlet for fuel and a plurality of openings that are in fluid communication with the oxidation pipe. The oxidation pipe has an inlet for preheated oxidant, an outlet for combustion products and a flow path between the inlet and outlet. The fuel is introduced into the fuel pipe, and it passes through the openings into the oxidation pipe. The oxidant and/or fuel are preheated such that when they are mixed in the heater the mixture is at or above the auto ignition temperature of the mixture. In this embodiment, the openings are generally drilled or cut into the wall of the fuel conduit. The openings may be circular, elliptical, rectangular, of another shape, or even irregularly shaped. The openings typically have a cross-sectional area of from about 0.001 cm² to about 2 cm², preferably from about 0.03 cm² to about 0.2 cm². The size of the openings is determined by the desired rate of fuel introduction into the oxidation conduit, but openings that are too small may result in plugging.

Different openings along the length of the heater typically have the same cross-sectional area. In an alternative embodiment the cross-sectional area of the openings may be different along the heater to provide a desired heat release. Additionally, the spacing between openings along the fuel conduit may be different. The openings are typically the same shape, but in the alternative they may be different shapes.

The flameless combustion heater may additionally comprise a process conduit that carries a process fluid where the process conduit is in heat exchange relationship with the oxidation conduit. The inclusion of a process conduit in the heater allows for direct heating of a process stream. The process conduit may optionally be used to carry out a chemical reaction. The process conduit may contain catalyst to facilitate the chemical reaction. This heater is especially useful for carrying out endothermic reactions because heat is added directly to the process during the reaction. For example, this heater may be incorporated into the dehydrogenation reactor to directly heat the dehydrogenation reaction of ethylbenzene to styrene.

The flameless combustion heater may optionally comprise an oxidant conduit. The oxidant conduit has an inlet for oxidant and an outlet for preheated oxidant that is in fluid communication with the inlet of the oxidation conduit. The oxidant conduit is in a heat exchange relationship with the oxidation conduit and/or the process conduit, which provide direct heat to preheat the oxidant to a temperature sufficient that when mixed with fuel in the oxidation conduit the mixture is at or above the auto ignition temperature.

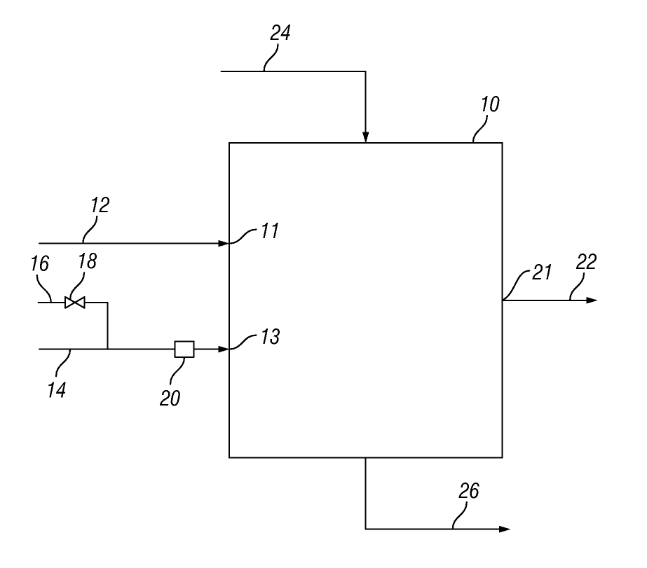

FIG. 1 depicts a general diagram of a flameless combustion heater (10) and the location of a preheater (20) containing an oxidation catalyst used to improve the startup behavior and stable operation of the heater. The heater has a fuel inlet (11), an oxidant inlet (13), and an oxidation products outlet (21). The heater also has a process inlet (24) and a process outlet (26). A fuel slipstream pipe (16) provides for fuel flow to the oxidant inlet pipe (14). The fuel flow may come from the main fuel inlet pipe (12) or a separate fuel system. A fuel valve (18) controls the flow through the fuel slipstream pipe.

The preheater (20) is preferably located within the oxidant inlet pipe. The preheater preferably comprises a supported oxidation catalyst. A static mixer may be placed in the oxidant inlet pipe, upstream of the catalyst to provide for improved mixing of the fuel and oxidant in the oxidant inlet pipe. Alternatively, the fuel may enter the oxidant inlet pipe far enough upstream to mix well. Effective mixing typically occurs when the fuel enters the inlet pipe at a distance of fifteen times the diameter of the oxidant inlet pipe from the oxidation catalyst.

When fuel is introduced into the oxidant inlet pipe (14), the pipe will contain preheated oxidant and combustion products from the reaction and both will be transported to the flameless combustion heater via oxidant inlet (13). The amount of fuel introduced into the oxidant inlet pipe is controlled such that only a portion of the oxidant undergoes flameless combustion in the preheater.

The oxidation catalyst may be any catalyst that promotes the flameless combustion reaction of the fuel being used. The oxidation catalyst may comprise a noble metal, for example, platinum, palladium, rhodium, silver, iridium, gold or combinations thereof. In the alternative, the oxidation catalyst may comprise a base metal, for example, copper, iron, manganese, vanadium, bismuth, cobalt, chromium, molybdenum, ruthenium, tungsten, rhenium or combinations thereof. The metals may be supported on ceramic substrates including alumina, ceria, zirconia, titania, silica, or combinations thereof modified with lanthanides. The catalyst may be in the form of simple spheres or extrudates, for example, cylinders, hollow cylinders, and trilobes. The catalyst may be in the form of metallic or ceramic monoliths, reticulated metallic or ceramic foams or coated metal wires, for example, gauzes, meshes, and spiral wound structures.

The invention provides a method for starting up the flameless combustion heater system. During startup of the heater, fuel passes through the fuel slipstream pipe to assist in preheating the oxidant. The oxidation catalyst in the oxidant inlet pipe allows flameless combustion to occur at a lower temperature, and the heat provided by this flameless combustion in the oxidant inlet pipe will raise the temperature of the oxidant entering the heater (10) through oxidant inlet (13). This allows the temperature of the oxidant to be raised to a temperature that will be above the auto-ignition temperature when mixed with fuel inside the flameless combustion heater (10). After the auto ignition temperature is reached in the heater, the fuel valve (18) may be closed to stop the flow of fuel into the oxidant inlet pipe (14). The catalyst remains in line (14), but there is no flameless combustion in the pipe because there is no fuel in line (14). This allows the oxidation catalyst to be used to assist in starting up the heater system, but then allows the heater to operate at temperatures above those that would be possible if the oxidation catalyst were in the heater. The catalyst does not need to be removed from the system for it to stop affecting the flameless combustion in the heater.

The invention also provides a method for controlling the operation of the heater to maintain the stability of the heater. During operation of the heater, the fuel valve (18) may be controlled to control the temperature of the oxidant entering the heater to ensure that the resulting fuel/oxidant temperature stays above the auto-ignition temperature of the fuel/oxidant mixture. The flameless heater combustion system may experience instability or upsets if the temperature of the oxidant being introduced into the heater changes because the resulting fuel/oxidant mixture in the heater may be below the auto ignition temperature of the mixture. If this occurs, then the flameless combustion may cease and the heater will cool down.

According to this method, the temperature of the heater may be determined. This temperature may be compared with the auto ignition temperature of the mixture being fed to the heater. It is preferred for the temperature of the mixture to be maintained above the auto ignition temperature and more preferred to maintain the temperature of the mixture at least 10° C. above the auto ignition temperature of the mixture, and most preferred to maintain the temperature of the mixture at least 20° C. above the auto ignition temperature of the mixture. If the temperature of the heater begins to decrease towards the auto ignition temperature of the mixture, then the fuel valve (18) may be opened to allow an incremental fuel flow from the fuel slipstream pipe such that a flameless combustion reaction occurs at the oxidation catalyst placed in the oxidant inlet pipe. This flameless combustion reaction will preheat the oxidant and the heater temperature will be increased. The fuel valve may be controlled to provide for stable operation of the flameless combustion heater system.

The oxidation catalyst may be alternatively placed in the fuel line and a slipstream of oxidant may be passed to the fuel inlet pipe. It is preferable, however, to preheat the oxidant because excessive preheating of the fuel may result in coking of the fuel inlet pipe.

The flameless combustion heater may be operated at a variety of conditions depending on the particular configuration of heater and the heater application. Various examples and conditions are described in U.S. Pat. No. 7,025,940, which are herein incorporated by reference. The flameless combustion heater system may be used in steam reforming, cracking or various other processes.

The flameless combustion heater system of the present invention can be used in the dehydrogenation of ethylbenzene to produce styrene. This is typically carried out in the presence of an iron oxide based dehydrogenation catalyst. The reaction typically occurs between about 550° C. and 680° C. The heater of the present invention can also be used in a steam reforming system where steam and hydrocarbons are converted to hydrogen, carbon monoxide and carbon dioxide. The temperature of this reaction is typically from about 800° C. to 870° C.

The auto-ignition temperatures of different fuels in the presence of oxidation catalysts are described in U.S. Pat. No. 5,899,269, which is herein incorporated by reference. Some auto-ignition temperatures relevant to this invention are laid out in Table 1.

TABLE 1

| | Measured Auto- | | |
|---|---|---|---|
| | ignition | Fuel Conc. | |
| | Temperature ° F. | % of Air | |
| Fuel | (° C.) | Volume | Catalyst |
| Natural gas | 1450 (788) | 10.5 | None |
| Methane | 590 (310) | 13 | Pd |
| Hydrogen | 1218 (659) | 13 | None |
| Hydrogen | 120 (49) | 13 | Pt |
| Hydrogen | 300 (149) | 13 | Pd |
| 66.6% Hydrogen, | 1249 (676) | 13 | None |
| 33.3% CO | | | |
| 66.6% Hydrogen, | 416 (213) | 13 | Pt |
| 33.3% CO | | | |
| 66.6% Hydrogen, | 310 (154) | 13 | Pd |
| 33.3% CO | | | |

As can be seen from the table, the catalyzed auto ignition temperatures are significantly lower than the non-catalyzed auto ignition temperatures. The styrene and steam methane reforming processes described above require the process stream to be heated to above 550° C. and 800° C., respectively. It would be difficult for a heater that is maintained at a temperature slightly above the catalyzed auto-ignition temperature to heat the process streams to the required temperatures. On the other hand, a heater that is maintained at a temperature slightly above the non-catalyzed auto ignition temperature would be more able to provide the heat needed by the above-mentioned processes. The oxidation catalyst is helpful in maintaining stability of the heater operation when used according to this invention without significantly lowering the auto ignition temperature of the mixture inside the heater.

The flameless combustion heater described herein can be used in any application with any variation of the described details of opening location and geometry.

What is claimed:

1. A flameless combustion heater system comprising: a flameless combustion heater; an oxidant inlet pipe; a fuel inlet pipe; and a preheater for preheating the oxidant or the fuel, said preheater comprising an oxidation catalyst.

2. A flameless combustion heater system as claimed in claim 1 wherein the preheater is in fluid communication with the oxidant inlet pipe and fuel is introduced into the oxidant inlet pipe upstream of the preheater such that a fuel-oxidant mixture is passed through the preheater.

3. A flameless combustion heater system as claimed in claim 2 wherein the preheater is located within the oxidant inlet pipe.

4. A flameless combustion heater system as claimed in claim 1 wherein the preheater is in fluid communication with the fuel inlet pipe and oxidant is introduced into the fuel inlet pipe upstream of the preheater such that a fuel-oxidant mixture is passed through the preheater.

5. A flameless combustion heater system as claimed in claim 4 wherein the preheater is located within the fuel inlet pipe.

6. A flameless combustion heater system as claimed in claim 1 wherein the oxidation catalyst comprises a noble metal.

7. A method for starting up a flameless combustion heater system as claimed in claim 2 comprising passing oxidant through the oxidant inlet pipe, introducing fuel into the oxidant inlet pipe upstream of the preheater such that flameless combustion occurs in the preheater, passing the resulting heated oxidant through the flameless combustion heater until the heater is above the auto ignition temperature of the desired mixture of fuel and oxidant, and then passing fuel through the fuel inlet pipe such that flameless combustion occurs in the heater.

8. A method for starting up a flameless combustion heater system as claimed in claim 3 comprising passing oxidant through the oxidant inlet pipe, introducing fuel into the oxidant inlet pipe upstream of the preheater such that flameless combustion occurs in the preheater, passing the resulting heated oxidant through the flameless combustion heater until the heater is above the auto ignition temperature of the desired mixture of fuel and oxidant, and then passing fuel through the fuel inlet pipe such that flameless combustion occurs in the heater.

9. A method as claimed in claim 7 further comprising stopping the flow of fuel into the oxidant inlet pipe.

10. A method as claimed in claim 8 further comprising stopping the flow of fuel into the oxidant inlet pipe.

11. A method for controlling the temperature of a flameless combustion heater system as claimed in claim 2 comprising: determining the temperature of the oxidant being introduced into the heater and adjusting the fuel flow into the oxidant inlet pipe.

12. A method for controlling the temperature of a flameless combustion heater system as claimed in claim 3 comprising: determining the temperature of the oxidant being introduced into the heater and adjusting the fuel flow into the oxidant inlet pipe.

13. A method for starting up a flameless combustion heater system as claimed in claim 4 comprising passing fuel through the fuel inlet pipe, introducing oxidant into the fuel inlet pipe upstream of the preheater such that flameless combustion occurs in the preheater, passing the resulting heated fuel through the flameless combustion heater until the heater is above the auto ignition temperature of the desired mixture of fuel and oxidant, and then passing oxidant through the oxidant inlet pipe such that flameless combustion occurs in the heater.

14. A method for starting up a flameless combustion heater system as claimed in claim 5 comprising passing fuel through the fuel inlet pipe, introducing oxidant into the fuel inlet pipe upstream of the preheater such that flameless combustion occurs in the preheater, passing the resulting heated fuel through the flameless combustion heater until the heater is above the auto ignition temperature of the desired mixture of fuel and oxidant, and then passing oxidant through the oxidant inlet pipe such that flameless combustion occurs in the heater.

15. A method as claimed in claim 13 further comprising stopping the flow of oxidant into the fuel inlet pipe.

16. A method as claimed in claim 14 further comprising stopping the flow of oxidant into the fuel inlet pipe.

17. A method for controlling the temperature of a flameless combustion heater system as claimed in claim 4 comprising: determining the temperature of the fuel being introduced into the heater and adjusting the oxidant flow into the fuel inlet pipe.

18. A method for controlling the temperature of a flameless combustion heater system as claimed in claim 5 comprising: determining the temperature of the fuel being introduced into the heater and adjusting the oxidant flow into the fuel inlet pipe.
